(19) United States
(12) Patent Application Publication
(10) Pub. No.: US 2026/0230282 A1
(43) Pub. Date: Aug. 6, 2026

(54) METHODS ON PRIORITIZING CHANNEL STATE INFORMATION (CSI) REPORTING FOR ARTIFICIAL INTELLIGENCE (AI) / MACHINE LEARNING (ML)

(71) Applicant: InterDigital Patent Holdings, Inc., Wilmington, DE (US)

(72) Inventors: Young Woo Kwak, Woodbury, NY (US); Yugeswar Deenoo Narayanan Thangaraj, Chalfont, PA (US); Dylan Watts, Montreal (CA); Patrick Tooher, Montreal (CA); Oumer Teyeb, Montreal (CA); Haseeb Ur Rehman, Winnipeg (CA)

(73) Assignee: InterDigital Patent Holdings, Inc., Wilmington, DE (US)

(21) Appl. No.: 19/044,269

(22) Filed: Feb. 3, 2025

(51) Int. Cl. H04L 5/00; H04B 7/06

(52) U.S. Cl. CPC H04L 5/0057; H04B 7/0626

(57) ABSTRACT

A WTRU may receive configuration information indicating a first AI/ML CSI report configuration, a second AI/ML CSI report configuration, a first CSI reporting configuration type associated with the first AI/ML CSI report configuration, and/or a second CSI reporting configuration type associated with the second AI/ML CSI report configuration. The WTRU may determine a first priority associated with each CSI report configuration based on a prediction accuracy associated with each AI/ML CSI report configuration and/or each CSI reporting configuration types. The WTRU may determine a second priority based on the first and second AI/ML CSI report configurations being activated for the same usage. The second priority may be determined based on whether the prediction accuracy of each AI/ML CSI report configuration is above a threshold and/or one or more configurations associated with each AI/ML CSI report configuration.

### BACKGROUND

Artificial intelligence may be referred to as the behaviour exhibited by machines. Such behaviour may, for example, mimic cognitive functions to sense, reason, adapt, and/or act.

Machine learning may refer to a type of algorithms that address one or more problems based on learning through experience and/or data, without (e.g., explicitly) being programmed (e.g., configuring set of rules). Machine learning can be considered as a subset of AI. Different machine learning paradigms may be envisioned based on the nature of data and/or feedback available to the learning algorithm. For example, a supervised learning approach may include learning a function that maps input to an output based on labelled training example, where each training example may be a pair including input and the corresponding output. For example, unsupervised learning approach may include detecting patterns in the data with no pre-existing labels. For example, reinforcement learning approach may include performing a sequence of actions in an environment to maximize the cumulative reward. In examples, it may be possible to apply machine learning algorithms using a combination and/or interpolation of the approaches described herein. For example, semi-supervised learning approach may use a combination of a small amount of labelled data with a large amount of unlabelled data during training. In this regard, semi-supervised learning may fall between unsupervised learning (e.g., with no labelled training data) and supervised learning (e.g., with only labelled training data).

### SUMMARY

A wireless transmit/receive unit (WTRU) may determine priority of channel state information (CSI) report configuration based on CSI report configuration(s) and/or prediction performance of CSI report configurations. Embodiments described herein may include a WTRU configured to determine a central processing unit (CPU) type and/or occupation timing based on channel state information (CSI) report configuration. For example, a WTRU may determine to apply CPU type and/or occupation for CSI report configuration. For example, a WTRU may determine to apply CPU type and/or occupation and/or artificial intelligence (AI)/machine learning (ML) CPU type and/or occupation for AI/ML CSI report configuration.

Embodiments described herein may include a WTRU configured to determine a priority type and/or value of priority based on CSI report configuration. For example, a WTRU may determine to apply priority and/or value and/or artificial intelligence (AI)/machine learning (ML) priority type and/or value for AI/ML CSI report configuration.

A WTRU may determine CPU duration based on CSI report configuration. A WTRU may apply the determine CPU during a first type of duration (e.g., from reference signal (RS) measurement/activation/trigger to the report) for a first type of CSI report configuration (e.g., beam management-case1). A WTRU may apply the determined CPU during a second type of duration (e.g., from RS measurement until RS measurement+T3 and/or from T4 before reporting until WTRU reporting).

A WTRU may receive configuration information. The configuration information may indicate a plurality of CSI report configurations and/or a respective CSI reporting configuration type associated with each CSI report configuration of the plurality of CSI report configurations. The plurality of CSI report configurations may include at least two artificial intelligence (AI)/machine learning (ML) CSI report configuration. The configuration information may indicate a first AI/ML CSI report configuration, a second AI/ML CSI report configuration, a first CSI reporting configuration type associated with the first AI/ML CSI report configuration, and/or a second CSI reporting configuration type associated with the second AI/ML CSI report configuration. The WTRU may send an indication that indicates applicability of each AI/ML CSI report configuration (e.g., of the at least two AI/ML CSI report configurations, of a plurality of CSI report configurations). The WTRU may send an indication that indicates applicability of the first AI/ML CSI report configuration and/or the second AI/ML CSI report configuration. The WTRU may determine a first priority associated with each (e.g., AI/ML) CSI report configuration (e.g., of the plurality of CSI report configurations) based on a prediction accuracy associated with each (e.g., first and/or second) AI/ML CSI report configuration and/or the (e.g., first and/or second) CSI reporting configuration types. The WTRU may determine a second priority based on each (e.g., the first and/or second) AI/ML CSI report configurations (e.g., of the plurality of CSI report configurations) being activated for the same usage. The second priority may be determined based on whether the prediction accuracy of each AI/ML CSI report configuration is above a threshold and/or one or more configurations and/or parameters associated with each AI/ML CSI report configuration. The WTRU may send an indication of CSI associated with at least the first and/or second AI/ML CSI report configurations based on the first priority and/or the second priority.

The plurality of CSI report configurations may include non-AI/ML CSI report configurations. The configuration information may include no-AI/ML CSI report configurations. The WTRU may determine the first priority based on non-AI/ML CSI report configurations, the first AI/ML CSI report configuration, and/or the second AI/ML CSI report configuration.

The plurality of CSI report configurations may include a first CSI report configuration and/or a second CSI report configuration. The WTRU may determine the second priority when the priority associated with the first CSI report configuration is the same priority associated with the second CSI report configuration.

When the prediction accuracy corresponding to the first or second AI/ML CSI report configuration is lower than the threshold, the WTRU may remove a priority associated with the first or second AI/ML CSI report configuration.

The configuration information may include a respective usage and/or functionality for each CSI report configuration of the plurality of CSI report configurations. Each respective usage and/or functionality may be indicative of a purpose of each CSI report configuration. The purpose of may include one or more of a CSI purpose, a beam management purpose, and/or a positioning purpose.

The configuration information may include a plurality of CSI report configurations. The plurality of CSI report configuration may include the first AI/ML CSI report configuration and/or the second AI/ML CSI report configuration. The WTRU may send information associated with the first and/or second priority associated with the plurality of CSI report configurations to send the indication of CSI.

The WTRU may determine the applicability of each AI/ML CSI report configuration based at least on one or more characteristics and/or parameters and/or configurations associated with each AI/ML CSI report configuration and/or the usage and/or functionality. For example, the WTRU may determine each AI/ML CSI report configuration as applicable if one of AI/ML models is trained by using the AI/ML CSI report configuration. Otherwise, the WTRU may determine the AI/ML CSI report configuration as not applicable. Each AI/ML CSI report configuration (e.g., the first AI/ML CSI report configuration and/or the second AI/ML CSI report configuration) may be activated based on a determination that each AI/ML CSI report configuration is applicable.

The WTRU may determine the first priority and/or the second priority based on WTRU capability. The WTRU may determine the first priority and/or the second priority based on one or more of an indication and/or one or more parameters associated with each AI/ML CSI report configuration (e.g., of the plurality of CSI report configurations). The one or more parameters associated with each CSI report configuration of the plurality of CSI report configurations may include one or more of a use case, a reference signal (RS) type, a number of RS ports, a transmission periodicity, and/or the applicability.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

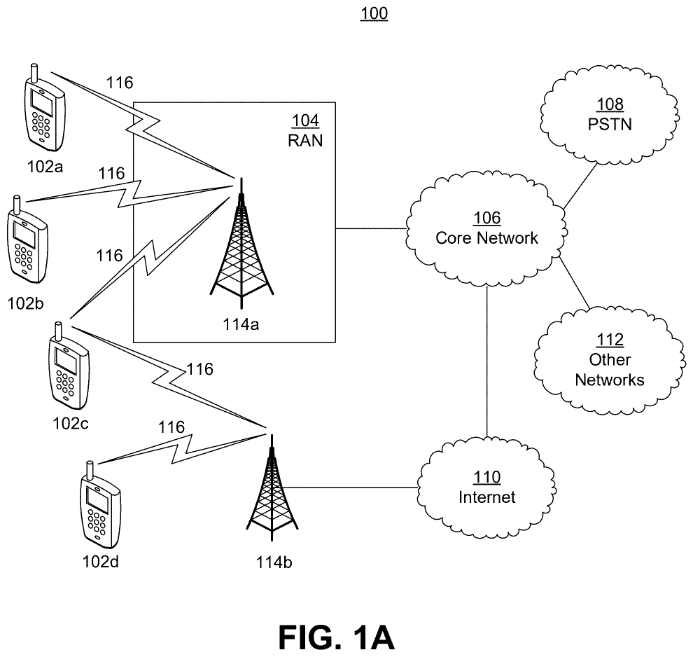

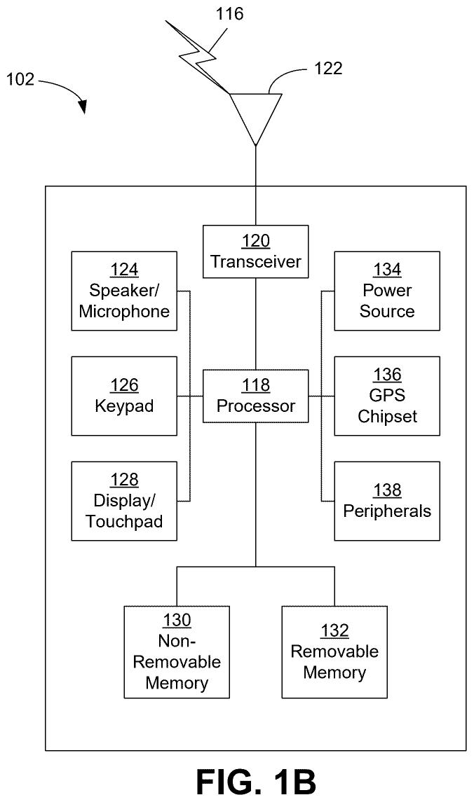

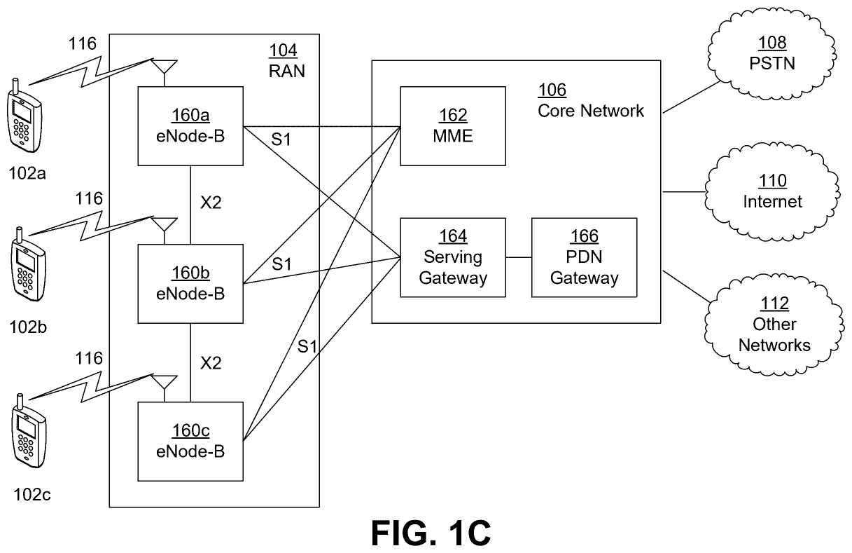

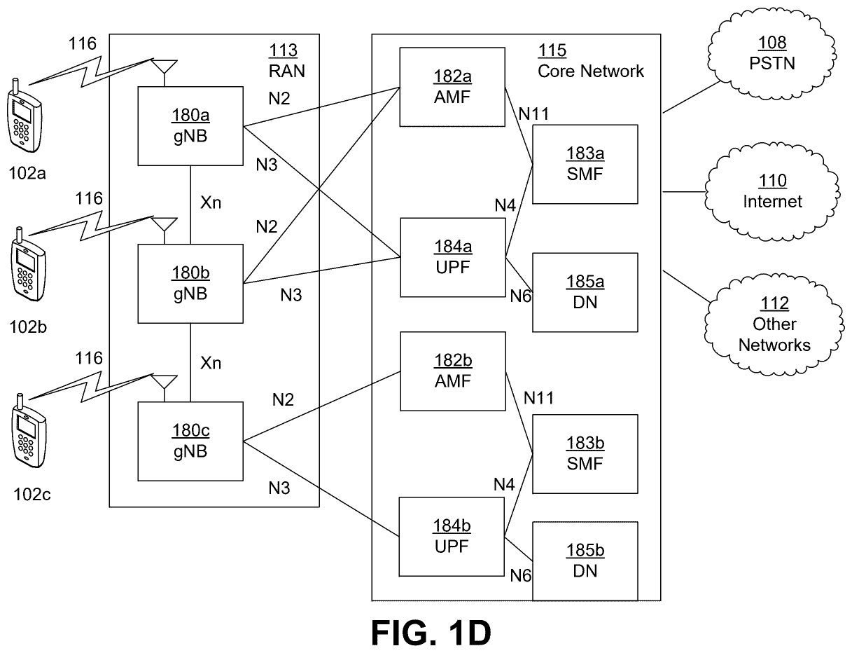

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Artificial intelligence (AI)/machine learning (ML) for NR air interface may be discussed herein, which may include one or more of the following objectives for framework and/or model identification. Beam management may include downlink (DL) transaction (Tx) beam prediction for (e.g., both) wireless transmit/receive unit (WTRU)-sided model and/or network (NW)-sided model including RAN1 and/or RAN2. For example, beam management may include spatial-domain DL Tx beam prediction for Set A of beams based on measurement results of Set B of beams (BM-Case1). For example, beam management may include temporal DL Tx beam prediction for Set A of beams based on the historic measurement results of Set B beams (BM-Case2). For example, beam management may specify signaling and/or mechanism(s) to facilitate life cycle management (LCM) operation(s) specific to the beam management use case(s). For example, beam management may include enabling one or more methods to ensure consistency between training and inference regarding NW-side additional conditions (e.g., if identified) for inference at the WTRU. Beam management may include striving for a framework design to support (e.g., both) BM-Case1 and/or BM-Case2.

Embodiments described herein may include DL Tx beam for (e.g., both) WTRU-sided model and/or NW-sided model in (e.g., both) spatial domain and/or temporal domain. WTRU applicability reporting and/or activation of CSI report configurations may be described herein. For example, a NW may send one or more of the following configurations to the WTRU. A WTRU may perform UAI reporting via OtherConfig. The applicability report may be based on a first configuration and/or a second configuration. It may be up to RAN 2 to design the container. The first configuration may include one or more CSI-ReportConfig for inference configuration. The associated identification (ID) may be configured in channel state information (CSI) framework (e.g., as working assumption applied). CSI report configuration for WTRU-side model inference may not be activated (e.g., immediately) upon receiving the configuration. The second configuration may include one or more (e.g., multiple) sets of inference related parameters for applicability report (e.g., only, not for inference). It may be up to RAN 2 to design the container. The set of inference related parameters may be selected from information elements (IEs) in/or the IEs referred by CSI-ReportConfig as a starting point. IEs may include the associated ID (e.g., may not imply the associated ID is mandatory), set A related information, set B related information, and/or report content related information. For BM-Case 2, IEs may include time instances related information for measurements and/or time instances related information for prediction. A WTRU may report applicability for one or more (e.g., all) of the above (e.g., first configuration: one or more CSI-ReportConfig and/or second configuration: set(s) of inference related parameters). FFS on whether/what other information along with the applicability may be included. If the first configuration is included (E.g., A), applicable aperiodic CSI report and/or semi-persistent CSI report can be activated/triggered by NW after the applicability report and/or applicable periodic CSI report may be considered as activated (e.g., only) if the applicability of the corresponding CSI-ReportConfig is reported in RRCReconfigurationComplete message. A NW can configure (e.g., in a fifth procedure) the CSI-ReportConfig for inference configuration in RRCReconfiguration. The associated ID may be configured in CSI framework. Procedure 5 may be optional if the WTRU has been configured with CSI-ReportConfig in a third procedure.

For the CSI-ReportConfig for inference configuration (e.g., sent in the fifth procedure), aperiodic CSI report and/or semi-persistent CSI report can be activated/triggered by NW after RRCReconfigurationComplete and/or periodic CSI report may be considered as activated after RRCReconfigurationComplete. A WTRU may not be expected to be configured with a CSI-ReportConfig for inference configuration for a non-applicable set of inference parameters and/or a non-applicable CSI-ReportConfig.

In CSI reporting, a gNB may configure periodic CSI report configuration(s) to be activated considering WTRU capability (e.g., as Table 1 illustrates). In AI/ML CSI reporting, periodic CSI report configuration(s) may be configured for applicability report without prior information on WTRU applicability. The gNB may configure one or more CSI report configurations (e.g., for a same usage) so that the WTRU may indicate at least one applicable CSI reportconfiguration among the one or more CSI report configurations. As periodic CSI report configuration(s) may be (e.g., directly) activated based on indicating WTRU's applicability report, one or more periodic CSI report configurations may be activated (e.g., considering WTRU applicability report). For example, if the WTRU indicates (e.g., only) one applicable configuration (e.g., as Table 2 depicts), there may be no duplicated activated CSI report configuration. If the WTRU indicates one or more applicable configurations (e.g., as shown in Table 3), there may be one or more activated CSI report configurations (e.g., for a same usage).

TABLE 1
Configuration/activation of non-AI/ML CSI configs

| | CSI report | UE applicability | |
|---|---|---|---|
| Functionality | config ID | report | Status |
| CSI | CSI config #1 | N/A | Activated |
| Beam | CSI config #2 | N/A | Activated |

TABLE 2
Configuration/activation of AI/ML CSI configs
with non-duplicated applicability

| | CSI report | UE applicability | |
|---|---|---|---|
| Functionality | config ID | report | Status |
| CSI | CSI config #1 | Applicable | Activated after the |
| | | | applicability report |
| CSI | CSI config #2 | Not applicable | Deactivated |
| Beam | CSI config #3 | Applicable | Activated after the |
| | | | applicability report |
| Beam | CSI config #4 | Not applicable | Deactivated |

TABLE 3
Configuration/activation of AI/ML CSI
configs with duplicated applicability

| | CSI report | UE applicability | |
|---|---|---|---|
| Functionality | config ID | report | Status |
| CSI | CSI config #1 | Applicable | Activated after the |
| | | | applicability report |
| CSI | CSI config #2 | Applicable | Activated after the |
| | | | applicability report |
| Beam | CSI config #3 | Applicable | Activated after the |
| | | | applicability report |
| Beam | CSI config #4 | Applicable | Activated after the |
| | | | applicability report |

As there may be no procedure to indicate applicability of CSI report configurations, a gNB may configure CSI report configurations considering WTRU capability; one or more (e.g., all) of the configured periodic CSI report configurations may be activated without additional procedure. Embodiments described herein may address how a WTRU handles applicable CSI report configurations.

A WTRU may determine priority of CSI report configurations based on CSI report configuration parameters and/or prediction performance of CSI report configurations.

A WTRU may receive one or more CSI report configurations. Each CSI report configuration may include at least one or more of the following parameters: A reference signal (RS) resource set for set A, a RS resource set for set B, a ReportQuantity, a CSI reporting configuration type (e.g., AI/ML and/or non-AI/ML), and/or a transmission type (e.g., periodic, semi-static, and/or aperiodic). For example, the WTRU may receive configuration information that indicates a first AI/ML CSI report configuration, a second AI/ML CSI report configuration, a first CSI reporting configuration type associated with the first AI/ML CSI report configuration, and/or a second CSI reporting type associated with the second AI/ML CSI report configuration. The WTRU may receive configuration information that indicates a plurality of CSI report configuration and/or a respective CSI reporting configuration type associated with each CSI report configuration of the plurality of CSI report configurations. The plurality of CSI report configurations may include one or more (e.g., at least two) AI/ML CSI report configurations. The configuration information may include non-AI/ML CSI report configurations. The configuration information may include a plurality of CSI report configurations. The plurality of CSI report configurations may include one or more non-AI/ML CSI report configuration(s). The plurality of CSI report configurations may include a first CSI report configuration and/or a second CSI report configuration. The configuration information may include respective functionality and/or usage for each CSI report configuration of the plurality of CSI report configurations. Each functionality and/or usage may be indicative of a purpose and/or task (e.g., purpose and/or task the WTRU is to perform). For example, functionality and/or purpose and/or task associated with each CSI report configuration may include a CSI (e.g., related) purpose and/or task, a beam management (e.g., related) purpose and/or task, and/or a positioning (e.g., related) purpose and/or task. Each functionality and/or usage may be indicative of each CSI report configuration of the plurality of CSI report configurations.

The WTRU may determine whether each (e.g., the first and/or the second) AI/ML CSI report is applicable. For example, the WTRU may determine whether each (e.g., the first and/or the second) AI/ML CSI report is applicable based at least on one or more configurations and/or parameters associated with each AI/ML CSI report configuration and/or the functionality (e.g., as described herein). There may be no determination of applicability associated with non-AI/ML CSI report configuration(s), for example, because non-AI/ML CSI report configurations may (e.g., always) be applicable. The one or more (e.g., first and/or second) AI/ML CSI report configurations may be activated based on a determination that each (e.g., first and/or second) AI/ML CSI report configuration is applicable. For example, the WTRU may activate the first AI/ML CSI report configuration based on a determination that the first AI/ML CSI report configuration is applicable. For example, the WTRU may activate the second AI/ML CSI report configuration based on a determination that the second AI/ML CSI report configuration is applicable.

The WTRU may indicate one or more of the applicable CSI report configurations of the one or more CSI report configurations. For example, the WTRU may send an indication that indicates applicability of each (e.g., the first and/or the second) AI/ML CSI report configuration (e.g., of at least two AI/ML CSI report configurations). The WTRU may send an indication that indicates applicability of the first AI/ML CSI report configuration and/or the second AI/ML CSI report configuration.

The WTRU may activate the one or more CSI report configurations based on the applicability and/or the transmission type. The WTRU may activate (e.g., only) one or more AI/ML CSI report configuration(s) based on a determination that the one or more AI/ML CSI report configurations are applicable. For example, periodic CSI report configurations may be activated based on the configuration (e.g., after RRCReconfigurationComplete). For example, semi-persistent CSI with physical uplink control channel (PUCCH) reporting configurations may be activated via medium access control control element (MAC-CE). For example, semi-persistent CSI with physical uplink shared channel (PUSCH) reporting configurations may be activated via downlink control information (DCI). For example, aperiodic CSI reporting may be triggered via DCI. The WTRU may not activate AI/ML CSI report configuration(s) (e.g., and/or associated functionality and/or usage) based on prediction accuracy. For example, if AI/ML usage and/or functionality is not activated, the WTRU may not determine prediction accuracy. The WTRU may deactivate CSI reporting with low prediction accuracy so that the WTRU may not report the information.

The WTRU may determine priority of one or more CSI report configurations. Priority can be determined based on a (e.g., common) rule. For example, the WTRU may not determine the priority based on prediction performance. In examples, the WTRU and/or the gNB may (e.g., both) determine priority based on (pre)defined rules (e.g., a priority equation). The WTRU may determine (e.g., non-AI/ML) priority of the one or more CSI report configurations and/or corresponding prediction accuracy (e.g., only for AI/ML CSI report configurations). For example, AI/ML CSI report configurations may be prioritized when corresponding prediction accuracy is higher than a threshold. Otherwise, AI/ML CSI report configuration(s) may be deprioritized. For example, when a WTRU is not able to report one or more (e.g., all) of the CSI reports according to the configured CSI report configuration(s), the WTRU may deprioritize (e.g., drop, not update) CSI report(s) associated with low priority CSI report configurations. For example, when the prediction accuracy corresponding to the first and/or second AI/ML CSI report configuration is lower than the threshold, the WTRU may determine a lower priority associated with the first and/or second AI/ML CSI report configuration. For example, the WTRU may use one or more equations to determine priority of one or more CSI report configurations (e.g., based on Pri_{iCSI}, (a, y, k, c, s)=3·N_{cells}·Mₛ·α+2·N_{cells}·Mₛ·y+N_{cells}·Mₛ·k+Mₛ·c+s). Where a=0 if CSI report configuration is for AI/ML and corresponding prediction accuracy is higher than a corresponding threshold. a=1 if CSI report configuration is for non-AI/ML. a=2 if CSI report configuration is for AI/ML and corresponding prediction accuracy is lower than a corresponding threshold. For example, the WTRU may determine a first priority associated with each (e.g., AI/ML) CSI report configuration (e.g., of the plurality of CSI report configurations) based on a prediction accuracy associated with each (e.g., first and/or second AI/ML) CSI report configuration and/or the (e.g., first and/or second) CSI report configuration types. The WTRU may determine the first priority based on the non-AI/ML CSI report configuration(s), the first AI/ML CSI report configuration, and/or the second AI/ML CSI report configuration. The WTRU may determine the first priority based on WTRU capability(ies) (e.g., as described herein).

If one or more AI/ML CSI report configurations are activated for the same usage, the WTRU may determine AI/ML priority for the AI/ML CSI report configurations of the one or more CSI report configurations. The same usage may refer to when one or more of the following (e.g., parameters, configurations) are the same between two AI/ML CSI report configurations: RS transmission type (e.g., periodic, semi-static, and/or aperiodic), report type (e.g., periodic, semi-static, and/or aperiodic), functionality and/or purpose (e.g., CSI, BM, and/or positioning), a target scenario (e.g., BM Case 1 or BM Case 2), a ReportQuantity, and/or the like. For example, the WTRU may determine a second priority based on the first and second AI/ML CSI report configuration (e.g., of the plurality of CSI report configurations) being activated for the same usage. The WTRU may determine the second priority based on whether the prediction accuracy of each (e.g., first and/or second) AI/ML CSI report configuration is above a threshold (e.g., as described herein) and/or based on one or more characteristics and/or configurations and/or parameters associated with each AI/ML CSI report configuration. The WTRU may determine the second priority when the priority associated CSI report configuration is the same priority associated with the second CSI report configuration.

The WTRU may prioritize AI/ML CSI report with the same usage based on one or more of the following. The WTRU may prioritize AI/ML CSI report based on a determination to prioritize BM-Case1 over BM-Case 2. The WTRU may prioritize AI/ML CSI report based on a determination to prioritize a larger number of CSI-RS ports (e.g., may be for Set A). The WTRU may prioritize AI/ML CSI report based on a determination to prioritize a smaller number of CSI-RS ports (e.g., may be for Set B). The WTRU may prioritize AI/ML CSI report based on a determination to prioritize shorter transmission periodicity. The WTRU may prioritize AI/ML CSI report based on a determination to prioritize a larger reporting periodicity. The WTRU may prioritize AI/ML CSI report based on a determination to prioritize stronger CSI prediction accuracy.

The WTRU may report CSI based on the determined priority and/or the AI/ML priority. For example, the WTRU may send an indication of CSI associated with at least the AI/ML CSI report configuration based on the first priority and/or the second priority. The WTRU may send information associated with the first and/or second priority associated with the plurality of CSI report configurations to send the indication of CSI. When the WTRU is not able to report and/or update one or more (e.g., all) of the CSI reporting based on the one or more CSI report configurations, the WTRU may determine and/or report one or more (e.g., some) CSI report configurations based on WTRU capability. For example, the WTRU may not be able to report one or more (e.g., all) of the configurations which are configured to be reported at the same/similar time instance. The WTRU may determine and/or report CSI report configuration(s) based on the priority(ies) (e.g., as described herein). If one or more CSI report configurations collide, the WTRU may report CSI based on a CSI report configuration with higher priority and higher AI/ML priority (e.g., if priority of CSI report configurations are the same). If one or more CSI report configurations require CPUs more than WTRU capability, the WTRU may update CSI based on a CSI report configuration with higher priority and higher AI/ML priority (e.g., if priority of CSI report configurations are the same).

Embodiments described herein may include a WTRU handling one or more activated CSI report configuration.

The words a and an and/or similar phrases may be interpreted as one or more and/or at least one. One or more terms with suffix (s) may be interpreted as one or ore and/or at least one. The term may may be interpreted as may, for example.

Artificial intelligence may be referred to as the behaviour exhibited by machines. Such behaviour may, for example, mimic cognitive functions to sense, reason, adapt, and/or act.

Machine learning may refer to a type of algorithms that address one or more problems based on learning through experience and/or data, without (e.g., explicitly) being programmed (e.g., configuring set of rules). Machine learning can be considered as a subset of AI. Different machine learning paradigms may be envisioned based on the nature of data and/or feedback available to the learning algorithm. For example, a supervised learning approach may include learning a function that maps input to an output based on labelled training example, where each training example may be a pair including input and the corresponding output. For example, unsupervised learning approach may include detecting patterns in the data with no pre-existing labels. For example, reinforcement learning approach may include performing a sequence of actions in an environment to maximize the cumulative reward. In examples, it may be possible to apply machine learning algorithms using a combination and/or interpolation of the approaches described herein. For example, semi-supervised learning approach may use a combination of a small amount of labelled data with a large amount of unlabelled data during training. In this regard, semi-supervised learning may fall between unsupervised learning (e.g., with no labelled training data) and supervised learning (e.g., with only labelled training data).

Deep learning may refer to a class of machine learning algorithms that employ artificial neural networks (e.g., specifically deep neural networks (DNNs)) which were loosely inspired from biological systems. The Deep Neural Networks (DNNs) may be a special class of machine learning models inspired by human brain, where the input is linearly transformed and pass-through non-linear activation function one or more times. DNNs may include one or more layers, where each layer may include a linear transformation and/or a given non-linear activation functions. The DNNs can be trained using the training data via back-propagation algorithm. DNNs may show (e.g., state-of-the-art) performance in one or more domains (e.g., speech, vision, natural language, etc.) and/or for one or more machine learning settings (e.g., supervised, un-supervised, and/or semi-supervised). The term AI/ML based methods/processing may refer to realization of behaviours and/or conformance to requirements by learning based on data, without explicit configuration of sequence of steps of actions. Such methods may enable learning complex behaviours, which may be difficult to specify and/or implement when using other (e.g., legacy) methods.

A WTRU may transmit and/or receive a physical channel and/or reference signal according to at least one spatial domain filter. The term beam may be used to refer to a spatial domain filter.

The WTRU may transmit a physical channel and/or signal using the same spatial domain filter as the spatial domain filter used for receiving an RS (e.g., such as CSI-RS) and/or a synchronization signal (SS) block. The WTRU transmission may be referred to as target, and/or the received RS and/or SS block may be referred to as reference and/or source. In examples, the WTRU may transmit the target physical channel and/or signal according to a spatial relation with a reference to such RS and/or SS block.

The WTRU may transmit a first physical channel and/or signal according to the same spatial domain filter as the spatial domain filter used for transmitting a second physical channel and/or signal. The first and/or second transmissions may be referred to as target and/or reference (and/or source), respectively. In examples, the WTRU may transmit the first (e.g., target) physical channel and/or signal according to a spatial relation with a reference to the second (e.g., reference) physical channel and/or signal.

A spatial relation may be implicit, configured by radio resource control (RRC), and/or signalled by MAC CE and/or DCI. For example, a WTRU may (e.g., implicitly) transmit PUSCH and/or demodulation RS (DM-RS) of PUSCH according to the same spatial domain filter as a sounding reference signal (SRS) indicated by a SRS resource indicator (SRI) indicated in DCI and/or configured by RRC. In examples, a spatial relation may be configured by RRC for an SRS resource indicator (SRI) and/or signalled by MAC CE for a PUCCH. Such spatial relation may (e.g., also) be referred to as a beam indication.

The WTRU may receive a first (e.g., target) downlink channel and/or signal according to the same spatial domain filter and/or spatial reception parameter as a second (e.g., reference) downlink channel and/or signal. For example, such association may exist between a physical channel (e.g., such as physical downlink control channel (PDCCH) and/or physical downlink shared channel (PDSCH)) and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS and/or SS block and a DM-RS by an index to a set of TCI states configured by RRC and/or signalled by MAC CE. Such indication may (e.g., also) be referred to as a beam indication.

A transmission and reception point (TRP) may be interchangeably used with one or more of a transmission point (TP), reception point (RP), radio remote head (RRH), distributed antenna (DA), base station (BS), a sector (e.g., of a base station), and/or a cell (e.g., a geographical cell area served by a BS). Multi-TRP may be interchangeably used with one or more of MTRP, M-TRP, and/or multiple TRPs.

A WTRU may report a subset of CSI components. The CSI components may correspond to at least a CSI-RS resource indicator (CRI), a synchronization signal block (SSB) resource indicator (SSBRI), an indication of a panel used for reception at the WTRU (e.g., such as a panel identify and/or group identity), measurements such as layer 1 (L1)-reference signal received power (RSRP), L1-signal to interference plus noise (SINR) (L1-SINR) taken from SSB and/or CSI-RS (e.g. cri-RSRP, cri-SINR, ssb-Index-RSRP, ssb-Index-SINR), and/or other CSI such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), a secondary synchronization signal (SSS), and/or a physical broadcast channel (PBCH). The WTRU may monitor, receive, and/or attempt to decode an SSB during initial access, initial synchronization, radio link monitoring (RLM), cell search, cell switching, and/or the like.

A WTRU may measure and/or report the CSI. The CSI for each connection mode may include and/or be configured with one or more of the following. The CSI for each connection mode may include and/or be configured with CSI report configuration, which may include one or more of: CSI report quantity (e.g., CQI, RI, PMI, CRI, LI, etc.); CSI report type (e.g., aperiodic, semi-persistent, periodic); SI report codebook configuration (e.g., Type I, Type II, Type II port selection, etc.); and/or CSI report frequency. The CSI for each connection mode may include and/or be configured with a CSI-RS resource set. The CSI-RS resource set may include one or more of the following CSI resource settings: non-zero power (NZP)-CSI-RS resource for channel measurement, NZP-CSI-RS resource for interference measurement, and/or CSI-interference measurement (CSI-IM) resource for interference measurement. The CSI for each connection mode may include and/or be configured with NZP CSI-RS resources. NZP CSI-RS resources may include one or more of the following: NZP CSI-RS resource ID, periodicity and/or offset; quasi co-location (QCL) information and/or TCI-state; and/or resource mapping (e.g., number of ports, density, code division multiplexing (CDM) type, etc.).

A WTRU may indicate, determine, and/or be configured with one or more reference signals. The WTRU may monitor, receive, and/or measure one or more parameters based on the respective reference signals. For example, one or more of the following may apply. The following parameters may be non-limiting examples of the parameters that may be included in reference signal(s) measurements: SS-RSRP, SS-SINR, CSI-SINR, received signal strength indicator (RSSI), cross-layer interference (CLI)-RSSI, and/or SRS-RSRP. One or more of these parameters may be included. Other parameters may be included.

SS reference signal received power (SS-RSRP) may be measured based on the synchronization signals (e.g., demodulation reference signal (DMRS) in PBCH and/or SSS). SS-RSRP may be referred to as the linear average over the power contribution of the resource elements (RE) that carry the respective synchronization signal. In measuring the RSRP, power scaling for the reference signals may be required. In case SS-RSRP is used for L1-RSRP, for example, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH and/or SSS). SS-SINR may be referred to as the linear average over the power contribution of the resource elements (RE) that carry the respective synchronization signal divided by the linear average of the noise and interference power contribution. In case SS-SINR is used for L1-SINR, for example, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, for example, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and/or non-serving cells, adjacent channel interference, thermal noise, and/or the like).

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and/or non-serving cells, adjacent channel interference, thermal noise, and/or the like).

Sounding reference signals RSRP (SRS-RSRP) may be measured based on the linear average over the power contribution of the resource elements (RE) that carry the respective SRS.

A CSI report configuration (e.g., CSI-ReportConfigs) may be associated with a single bandwidth part (BWP) (e.g., indicated by BWP-Id). One or more of the following parameters may be configured: CSI-RS resources and/or CSI-RS resource sets for channel and interference measurement; CSI-RS report configuration type including the periodic, semi-persistent, and/or aperiodic; CSI-RS transmission periodicity for periodic and/or semi-persistent CSI reports; CSI-RS transmission slot offset for periodic, semi-persistent, and/or aperiodic CSI reports; CSI-RS transmission slot offset list for semi-persistent and/or aperiodic CSI reports; one or more time restrictions for channel and/or interference measurements; report frequency band configuration (e.g., wideband/subband CQI, PMI, and/or the like); one or more thresholds and/or modes of calculations for the reporting quantities (e.g., CQI, RSRP, SINR, LI, RI, etc.); a codebook configuration; a group based beam reporting; a CQI table; a Subband size; a Non-PMI port indication; a Port Index; and/or the like.

A WTRU may be configured with a CSI-RS resource configuration. A CSI-RS resource set (e.g., NZP-CSI-RS-Resourceset) may include one or more of CSI-RS resources (e.g., NZP-CSI-RS-Resource and/or CSI-ResourceConfig). A WTRU may be configured with one or more of the following in a CSI-RS resource: CSI-RS periodicity and/or slot offset for periodic and/or semi-persistent CSI-RS resources; CSI-RS resource mapping to define the number of CSI-RS ports, density, CDM-type, OFDM symbol, and/or subcarrier occupancy; the bandwidth part to which the configured CSI-RS is allocated; and/or the reference to the TCI-state including the QCL source RS(s) and/or the corresponding QCL types(s).

One or more of the following configurations may be used for RS resource set. A WTRU may be configured with one or more RS resource sets. The RS resource set configuration may include one or more of the following: RS resource set ID; one or more RS resources for the RS resource set; a repetition (e.g., on, off); an aperiodic triggering offset (e.g., one of 0-6 slots); and/or TRS information (e.g., true or not).

One or more of the following configurations may be used for RS resource. A WTRU may be configured with one or more RS resources. The RS resource configuration may include one or more of the following: a RS resource ID; a resource mapping (e.g., REs in a physical resource block (PRB); a power control offset (e.g., one value of −8, . . . , 15); a power control offset with SS (e.g., −3 dB, 0 dB, 3 dB, 6 dB); a scrambling ID; a periodicity and/or offset; and/or QCL information (e.g., based on a TCI state).

A property of a grant and/or assignment may include one or more of the following. A property of a grant and/or assignment may include a frequency allocation. A property of a grant and/or assignment may include an aspect of time allocation (e.g., duration). A property of a grant and/or assignment may include a priority. A property of a grant and/or assignment may include a modulation and coding scheme. A property of a grant and/or assignment may include a transport block size. A property of a grant and/or assignment may include a number of spatial layers. A property of a grant and/or assignment may include a number of transports blocks. A property of a grant and/or assignment may include a TCI state, CRI, and/or SRI. A property of a grant and/or assignment may include a number of repetitions. A property of a grant and/or assignment may include whether the repetition scheme is Type A or Type B. A property of a grant and/or assignment may include whether the grant is a configured grant Type 1, type 2, and/or a dynamic grant. A property of a grant and/or assignment may include whether the assignment is a dynamic assignment and/or a semi-persistent scheduling (configured) assignment. A property of a grant and/or assignment may include a configured grant index and/or a semi-persistent assignment index. A property of a grant and/or assignment may include a periodicity of a configured grant and/or assignment. A property of a grant and/or assignment may include a channel access priority class (CAPC). A property of a grant and/or assignment may include one or more (e.g., any) parameters) provided in a DCI, by MAC, by LTE positioning protocol (LPP), and/or by RRC for the scheduling the grant and/or assignment.

An indication by DCI may include one or more of the following. An indication by DCI may include an (e.g., explicit) indication by a DCI field and/or by radio network temporary identifier (RNTI) used to mask cyclical redundancy check (CRC) of the PDCCH. An indication by DCI may include an (e.g., implicit) indication by a property such as DCI format, DCI size, CORESET and/or search space, aggregation level, first resource element of the received DCI (e.g., index of the first control channel element), and/or where the mapping between the property and the value may be signalled by RRC and/or MAC.

The WTRU may indicate the number of supported simultaneous CSI calculations N_{CPU} with parameter simultaneousCSI-ReportsPerCC in a component carrier, and/or simultaneousCSI-ReportsAllCC across one or more (e.g., all) component carriers. If a WTRU supports N_{CPU} simultaneous CSI calculations, it may have N_{CPU} CSI processing units for processing CSI reports. If L CPUs are occupied for calculation of CSI reports in a given OFDM symbol, the WTRU may have N_{CPU}−L unoccupied CPUs. If N CSI reports start occupying their respective CPUs on the same OFDM symbol on which N_{CPU}−L CPUs are unoccupied, where each CSI report n=0, . . . , N−1 corresponds to

$${O}_{CPU}^{( n )} ,$$

the WTRU may not (e.g., be required to) update the N−M requested CSI reports with lowest priority, where 0≤M≤N may be the largest value such that

$${\sum }_{n = 0}^{M - 1} {O}_{C P U}^{( n )} \leq {N}_{C P U} - L$$

holds.

For a CSI report with CSI-ReportConfig with higher layer parameter reportQuantity notsetto none, the CPU(s) may be occupied for a number of OFDM symbols as follows. A periodic and/or semi-persistent CSI report (e.g., excluding an initial semi-persistent CSI report on PUSCH after the PDCCH triggering the report and/or a semi-persistent CSI report on PUSCH configured with the higher layer parameter codebookType set to typeII-Doppler-r18 and/or typeII-Doppler-PortSelection-r18) may occupy CPU(s) from the first symbol of the earliest one of each CSI-RS/CSI-IM/SSB resource, and/or each CSI-RS/CSI-IM resource associated with one or more (e.g., all) configured sub-configurations for periodic CSI report corresponding to a CSI-ReportConfig that includes a list of sub-configurations provided by csi-ReportSubConfigList, and/or each CSI-RS/CSI-IM resource associated with one or more (e.g., all) triggered sub-configurations for semi-persistent CSI report corresponding to a CSI-ReportConfig that includes a list of sub-configurations provided by csi-ReportSubConfigList, for channel or interference measurement, respective latest CSI-RS/CSI-IM/SSB occasion no later than the corresponding CSI reference resource, until the last symbol of the configured PUSCH/PUCCH carrying the report. An aperiodic CSI report may occupy CPU(s) from the first symbol after the PDCCH triggering the CSI report until the last symbol of the scheduled PUSCH carrying the report. When the PDCCH reception includes two PDCCH candidates from two respective search space sets for the purpose of determining the CPU occupation duration, for example, the PDCCH candidate that ends later in time may be used. For example, the WTRU may use the PDCCH candidate that ends later in time.

An initial semi-persistent CSI report on PUSCH after the PDCCH trigger occupies CPU(s) from the first symbol after the PDCCH until the last symbol of the scheduled PUSCH carrying the report. For example, semi-persistent CSI on PUSCH may follow the same rule for aperiodic CSI for the initial report. For other report(s), it may follow the same rule(s) for semi-persistent CSI for PUCCH. When the PDCCH reception includes two PDCCH candidates from two respective search space sets for the purpose of determining the CPU occupation duration, the PDCCH candidate that ends later in time may be used. A semi-persistent CSI report on PUSCH configured with the higher layer parameter codebookType set to typeII-Doppler-r18 and/or typeII-Doppler-PortSelection-r18 may occupy CPU(s) from the first symbol of K_{P}-th latest consecutive periodic/semi-persistent CSI-RS occasions no later than CSI reference resource, until the last symbol of the PUSCH carrying the report, where the value of K_{P}∈{1, 2, 4} may be indicated by WTRU capability.

For a CSI report with CSI-ReportConfig with higher layer parameter reportQuantity set to none and CSI-RS-ResourceSet with higher layer parameter trs-Information not configured, the CPU(s) may be occupied for a number of OFDM symbols as follows. A semi-persistent CSI report (e.g., excluding an initial semi-persistent CSI report on PUSCH after the PDCCH triggering the report) may occupy CPU(s) from the first symbol of the earliest one of each transmission occasion of periodic and/or semi-persistent CSI-RS/SSB resource for channel measurement for L1-RSRP computation, until

$${Z}_{3}^{′}$$

symbols after the last symbol of the latest one of the CSI-RS/SSB resource for channel measurement for L1-RSRP condition in each transmission occasion. An aperiodic CSI report may occupy CPU(s) from the first symbol after the PDCCH triggering the CSI report until the last symbol between Z₃ symbols after the first symbol after the PDCCH triggering the CSI report and/or

$${Z}_{3}^{′}$$

symbols after the last symbol of the latest one of each CSI-RS/SSB resource for channel measurement for L1-RSRP computation.

TABLE 4
CSI computation delay requirement 2

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X₃ |
| 5 | 388 | 340 | 608 | 560 | min(388, X5 + KB3) | X5 |
| 6 | 776 | 680 | 1216 | 1120 | min(776, X6 + KB4) | X6 |

RS may be interchangeably used with one or more of RS resource, RS resource set, RS port, and/or RS port group. RS may be interchangeably used with one or more of SSB, CSI-RS, SRS, DM-RS, TRS, positioning RS (PRS), and/or phase tracking RS (PTRS). An RS may be used interchangeably herein with one or more of: SRS, CSI-RS, DM-RS, PT-RS, and/or SSB.

A channel may be used interchangeably herein with one or more of: PDCCH, PDSCH, physical uplink control channel (PUCCH), physical uplink shared channel (PUSCH), physical random access channel (PRACH), and/or the like.

A key performance indicator (KPI) may refer to one or more of the following. A KPI may refer to a signal quality (e.g., L1-RSRP, SINR, CQI, RSSI, reference signal received quality (RSRQ)). A KPI may refer to a prediction performance. For example, a prediction performance may include a percentage of the top-1 genie-aided (e.g., strongest) beam may be one of the top-k predicted beams. A KPI may refer to a link quality (e.g., throughput, block error rate (BLER)). A KPI may refer to data distribution (e.g., mean and/or variance of measured and/or predicted beam measurements). A KPI may refer to RSRP (e.g., L1-RSRP) difference (e.g., the difference between measured and predicted RSRP of a beam.

A signal, channel, and/or message (e.g., as in DL and/or uplink (UL) signal, channel, and/or message) may be used interchangeably herein. A RS resource set may be used interchangeably herein with a RS resource and/or a beam group. Beam reporting may be used interchangeably herein with CSI measurement, CSI reporting, and/or beam measurement. Embodiments described herein with respect to beam resources prediction may be used for beam resources belonging to a single and/or one or more (e.g., multiple) cells, and/or single and/or one or more (e.g., multiple) TRPs. CSI reporting may be used interchangeably herein with CSI measurement, beam reporting, and/or beam measurement. A RS resource set may be used interchangeably herein with a beam group. Set B may be used interchangeably herein with a set of RS resource sets, beams, beam-pairs, beam RS resources, RS resources, and/or a beam pattern. Set B may be used interchangeably herein with measurement RS resources, measurement RS resource set, measurement beam resources, measurement beam resource set, measurement beam pattern, measurement TCI states, measurement TCI state group, and/or the like. Set A may be used interchangeably herein with a set of RS resource sets, beams, beam-pairs, beam RS resources, RS resources, and/or a beam pattern. Beam prediction accuracy may be used interchangeably herein with prediction accuracy.

A WTRU may include capability to communicate between the WTRU and the network about AI/ML capability at the WTRU. For example, a WTRU may indicate to the network the supported AI/ML model(s) and/or function(s), confidence level of prediction(s), time horizon of prediction(s) (e.g., how far along in the future are the prediction(s) being made) and/or the like.

A WTRU may support one or more AI/ML models for a certain usage and/or functionality (e.g., with different prediction time horizons, prediction confidence levels, processing requirements, trained under/for operation in different frequencies/cells/location/times of day, etc.). A given AI/ML model can operate in different modes (e.g., with different levels of prediction confidence levels at different prediction time horizons, at different locations, frequencies, WTRU mobility pattern/speed, etc.).

The AI/ML model(s) can be available at the WTRU trained and/or the WTRU may receive an untrained AI/ML model(s) and train the AI/ML model(s). The AI/ML model(s) may be available at the WTRU trained, and/or the WTRU may be enabled and/or configured to perform (e.g., further) training (e.g., for different condition(s) such as frequencies/cells/location/times of day, for the same condition(s) as the initial training but for increasing the level of confidence and/or the prediction time horizon, for different WTRU speeds, etc.). The AI/ML model(s) may be available at the WTRU but not trained and/or (e.g., only) trained for certain WTRU/network conditions. The WTRU may be configured to train the AI/ML model(s) (e.g., for condition(s) that the AI/ML model(s) are not yet trained for).

In examples, the WTRU may require one or more configurations and/or inputs for performing the inference(s) using one or more AI/ML models. For example, for beam prediction, the WTRU may be configured with a certain number of beams to measure other beams (e.g., set A/B configuration as described herein). In examples, the WTRU may communicate the required configuration and/or input as part of the capability information. In examples, the required configuration and/or input may be communicated to the network based on a capability request (e.g., based on explicit network request, if the WTRU gets configured to perform AI/ML based on BM operations and/or it may have determined that the WTRU is lacking the required configuration and/or input(s), etc.).

AI/ML usage and/or functionality may be associated with a set of KPIs and/or metrics. For example, KPIs and/or metrics associated with AI/ML functionality and/or usage may include prediction accuracy, average and/or mean square difference between measured and predicted values, etc. For example, for the beam prediction, KPIs and/or metrics associated with AI/ML functionality and/or usage may include the beam prediction accuracy and/or confidence level, L1-RSRP difference between the measured and predicted beam levels, etc. A WTRU may have one or more AI/ML models for a given functionality and/or usage. Each AI/ML functionality and/or usage may have performance levels that meet different KPI thresholds (e.g., WTRU may have two models where a first AI/ML model has an accuracy level of 90% and a second AI/ML model has an accuracy level of 95%, etc.). The WTRU may inform the network during its capability reporting and/or based on (e.g., after) the capability reporting.

An AI/ML model may be trained under certain WTRU and/or network side (e.g., additional) conditions. For example, a WTRU-side condition may be the speed of the WTRU. A network side (e.g., additional) condition may be a condition related to a network configuration and/or setting that the WTRU may not be aware of, but may impact the performance of the model. For example, an AI/ML beam management model may perform differently if the AI/ML beam management model is trained when the network was using a certain antenna pattern, beam pattern, power levels, and/or the like. Additionally or alternatively, one or more aspects related to a network load may impact the (e.g., AI/ML) model performance.

Since a WTRU may not know one or more (e.g., all) details of the network side (e.g., additional) condition(s) (e.g., and/or the network may also not want to expose one or more of these implementations), the network may hide these details by signaling to the WTRU one or more associated IDs. For example, when data is being collected for training a model, tagging may be performed indicating under which network side (e.g., additional) condition(s) the model is being trained. When a WTRU is being configured to perform an AI/ML operation, for example, the WTRU may be configured to check the consistency between the condition(s) under which the AI/ML model is trained on and/or one or more current conditions (e.g., current WTRU conditions, current associated ID(s) signaled by the network indicating current network conditions and/or settings, etc.).

In examples, full and/or partial validity/applicability of an associated ID may refer to indicate whether the WTRU has an AI/ML model/functionality and/or usage that is valid/applicable for the concerned associated ID (e.g., the network may signal the same associated ID(s) to one or more WTRUs, and/or a first WTRU may determine the associated ID to be fully applicable, a second WTRU may determine it to be partially applicable, and/or a third WTRU may determine it to be not applicable.

The term life cycle management (LCM) may be used to describe the (e.g., overall) management aspects of AI/ML models. Aspects of AI/ML model(s) may include one or more of: model training; functionality/model identification; model delivery/transfer; model inference operation; functionality/model selection, activation, deactivation, switching, and/or fallback operation; functionality/model monitoring; model update; WTRU capability; and/or data collection (e.g., for model training, for monitoring, for inference, etc.). Functionality/model selection, activation, deactivation, switching, and/or fallback operation may include a decision by the network (e.g., network initiated and/or WTRU-initiated and requested to the network), a decision by the WTRU (e.g., event-triggered as configured by the network, WTRU's decision reported to the network, and/or a WTRU-autonomous with WTRU's decision reported to the network and/or without it). For example, a decision by the WTRU may include an autonomous decision made by the WTRU.

LCM can be functionality-based LCM and/or model-ID based LCM.

In functionality-based LCM, a network may indicate activation/deactivation/fallback/switching of AI/ML functionality via (e.g., 3GPP) signaling (e.g., RRC, MAC-CE, DCI). One or more models may not be identified at the network, and/or the WTRU may perform model-level LCM. A WTRU may have one AI/ML model for the functionality, and/or the WTRU may have one or more (e.g., multiple) AI/ML models for the functionality. In the functionality-based LCM, the WTRU may choose the AI/ML model(s) to use for a certain functionality (e.g., network decides for which functionalities the WTRU can use AI/ML based operation, and/or the WTRU may choose the AI/ML(s) model to use).

In model-ID based LCM, one or more models may be identified at the network, and/or the Network and/or WTRU may activate/deactivate/select/switch individual AI/ML models via model ID. In the model-ID based LCM, the network may (e.g., explicitly) control which particular model is used for a given AI/ML functionality. For example, the WTRU may send details of AI/ML model(s) and/or their capabilities; a network may determine which model to activate for a particular functionality.

Embodiments described herein may be applicable to (e.g., both) model-ID based and/or functionality-based LCM. Embodiments described herein may relate to how the WTRU determines whether it has a (e.g., AI/ML) model that is applicable for the indicated associated ID(s). For example, in the case of functionality-based LCM, the WTRU may be configured and/or requested to determine if a given functionality is valid/applicable, and/or the WTRU may perform the determination among one or more (e.g., all) of the models it has for a given functionality. The WTRU may consider the functionality applicable if at least one of the models is applicable. In examples, in the case of model-ID based LCM, the WTRU may be configured/requested by the network to determine whether a particular (e.g., AI/ML) model is applicable. For example, if an AI/ML model with a model ID was used for training, the WTRU may determine the AI/ML CSI report configuration associated with the AI/ML model applicable.

The activation of an associated ID may refer to a network configuring the WTRU with an associated ID to use and/or consider and/or (e.g., further) indicating to the WTRU to determine if the WTRU has an AI/ML model and/or functionality that is applicable for that associated ID (and/or sub-associated IDs).

In examples, the applicability of an associated ID may refer to the WTRU having an AI/ML functionality and/or (e.g., AI/ML) model that is applicable for the concerned associated ID (and/or related sub-associated IDs).

In the case of functionality-based LCM, for example, the WTRU may consider the associated ID applicable (and/or partially applicable) if there is at least one AI/ML model for that functionality that meets the applicability (and/or partially applicability) criteria, as described herein.

In the case of model-ID based LCM, for example, the WTRU may determine the associated ID's applicability (and/or partial applicability) for each AI/ML model for that functionality and/or the WTRU may be (e.g., explicitly) configured to determine a certain sub set of the AI/ML models. The WTRU may report the non-applicability, partial applicability, and/or (e.g., full) applicability for one or more (e.g., all) the models (and/or the configured sub set of models). For example, the WTRU may send a list of the applicable model(s), a list of the non-applicable model(s), a list of the partially applicable model(s), etc., and/or a bitmap indicating which model(s) are (e.g., partially) applicable and/or non-applicable, where the order in the bitmap is, for example, based on a model ID sorting order agreed upon the WTRU and the network, etc.).

An associated ID may be unique for a certain functionality and/or it may be shared among one or more functionalities. For the case where an associated ID can be applicable for more than one functionality, the WTRU may determine applicability for the associated ID for each of the concerned functionality(ies) according to one or more of the embodiments described herein. The WTRU may indicate to the network to which of the functionality(ies) the associated ID is applicable or not (e.g., a list of applicable functionalities, a list of non-applicable functionalities, a list of partially applicable functionalities, etc., and/or using a bitmap structure (e.g., as described herein, similar to the bitmap structure for the model ID based LCM, etc.).

In examples, the WTRU may be configured to start applying the AI/ML model and/or functionality if the WTRU determines the AI/ML model and/or functionality to be applicable for the configured and/or indicated associated ID. In examples, the WTRU may indicate the applicability to the network and/or may wait for an indication from the network to activate the AI/ML functionality and/or model.

In examples, the WTRU may be configured with a time duration. The WTRU may activate the concerned (e.g., AI/ML) functionality and/or model based on the configured time duration. For example, if the WTRU does not receive an indication from the network to not activate the concerned functionality and/or (e.g., AI/ML) model (e.g., within the time duration after the reception of the associated ID activation command, within the time duration after the sending of the applicability and/or partial applicability indication, within the time duration after the reception of a lower layer acknowledgement (ACK) indicating the reception of the application indication by the network, etc.), the WTRU may activate the concerned (e.g., AI/ML) functionality and/or model.

The one or more AI/ML functionalities described herein (e.g., beam management) may be a non-limiting list of examples. Other AI/ML functionalities may be associated with the embodiments described herein. For example, embodiments may be used for one or more AI/ML functionalities if the functionality is to be used in a multi-TRP scenario; the functionality may be impacted based on whether the WTRU operates in a single TRP and/or multi-TRP scenario. Embodiments described herein may be valid to one or more other forms of functionality that use prediction that is not based on AI/ML (e.g., time series forecasting, interpolation methods, etc.).

One or more (e.g., all of) the embodiments described herein may be agnostic to the kind of AI/ML model/technique(s) used by the WTRU. For example, one or more of the following may be agnostic to the kind of AI/ML model/technique(s) used by the WTRU: the algorithm used; the mechanism such as neural network and/or what kind of neural network (e.g., depth and/or parameters/weights of the network, etc.,); the origin(s) of the model (e.g., WTRU vendor, operator, network vendor, etc.,); and/or how and/or where the training of the model may be done (e.g., the input data used for the training, where the training is performed, if the training is performed offline or online, etc.,). The model may be trained on historical observation of one or more WTRUs' actual measurements in different WTRU and/or network conditions. For example, the model may be trained during certain time durations of the day, during certain days of the week, at different locations, different WTRU mobility patterns and/or speeds, under different network conditions that are visible to the WTRU (e.g., frequency and/or bandwidth, etc.), under different network configurations, which may be visible to the WTRU just as a network configuration index that is provided by the network at the time of training or data collection for the training, etc.,).

Sub-associated IDs may be described herein. Sub-associated IDs may not be limited to one level of grouping. An associated ID may include a group of sub-associated IDs. For example, embodiment(s) can include a sub-associated ID having one or more related sub-associated ID(s) of its own (e.g., one or more layers of grouping of associated IDs). Additionally or alternatively, a sub-associated ID may belong to more than one associated ID.

The terms functionality and procedure may be used interchangeable herein.

Embodiments described herein may include handling one or more (e.g., multiple) activated CSI report configurations based on priority. In examples, a WTRU may receive one or more CSI report configurations. Each CSI report configuration may include at least one or more of the following parameters. Each CSI report configuration may include one or more CSI resource configurations. A first CSI resource configuration may be associated with a RS resource set for set A and/or a second CSI resource configuration may be associated with a RS resource set for set B. Each CSI report configuration may include a CSI report quantity (e.g., CQI, RI, PMI, CRI, LI, etc.). Each CSI report configuration may include a CSI report type (e.g., aperiodic, semi-persistent, periodic). Each CSI report configuration may include a CSI report codebook configuration (e.g., Type I, Type II, Type II port selection, etc.). Each CSI report configuration may include a CSI report frequency.

In examples, the WTRU may receive one or more sets of inference configurations. Each set of inference configurations may include at least one or more of the following parameters. Each set of inference configurations may include one or more CSI resource configurations. A first CSI resource configuration may be associated with a RS resource set for set A. A second CSI resource configuration may be associated with a RS resource set for set B. Each set of inference configurations may include a CSI report quantity (e.g., CQI, RI, PMI, CRI, LI, etc.). Each set of inference configurations may include a CSI report type (e.g., aperiodic, semi-persistent, periodic). Each set of inference configurations may include a CSI report codebook configuration (e.g., Type I, Type II, Type II port selection, etc.). Each set of inference configurations may include a CSI report frequency. Each set of inference configurations may include one or more associated IDs. Each set of inference configurations may include set A related information. Each set of inference configurations may include set B related information. Each set of inference configurations may include report content related information. Each set of inference configurations may include, for BM-case 2, time instances related information for measurement(s) and/or time instances related information for prediction(s).

A WTRU may indicate applicability of the one or more CSI report configurations and/or the one or more sets of inference configurations. The WTRU may indicate applicability based on one or more of the following. The WTRU may indicate applicability if the WTRU receives RRC configuration and/or reconfiguration of one or more CSI report configuration(s) and/or one or more sets of inference related parameters. The WTRU may indicate applicability if one or more conditions are met. For example, if applicability of the one or more CSI reporting configurations and/or the one or more sets of inference related parameters change, the WTRU may trigger the indication of applicability. One or more condition(s) changes to trigger applicability may include activation and/or deactivation of corresponding RS resource set and/or activation of corresponding CSI report configuration.

In examples, the WTRU may indicate capability and/or support for one or more aspects of prioritized CSI reporting for AI/ML. In examples, the WTRU may indicate a single capability to indicate support for one or more (e.g., all) aspects of prioritized CSI reporting for AI/ML. In examples, the WTRU may report support for an/each aspect of prioritized CSI reporting for AI/ML. For example, the WTRU may indicate support for one or more of the following: prioritization of a CSI report configuration; AI/ML parameter-based prioritization of a CSI report configuration; prioritization of functionality; dynamic prioritization of CSI report configuration; and/or an indication of dynamically determined priority.

A WTRU may report the capability of one or more of the aspects (e.g., as described herein) of prioritized CSI reporting for AI/ML, for example, via the WTRU capability transfer procedure. In examples, the WTRU may indicate capability and/or support via one or more of the following methods. The WTRU may indicate capability and/or support via random access (and/or use of one or more dedicated resources, use of random access preamble partitioning (e.g., a set of reserved preambles and/or random access occasions, RNTIs, etc.). The WTRU may indicate capability and/or support upon RRC connection establishment and/or resumption (e.g., Msg3 and/or Msg5). The WTRU may indicate capability and/or support upon request from the network (e.g., upon reception of the capability enquiry message). The WTRU may indicate capability and/or support via WTRU assistance information.

In examples, capability to support/perform/execute/initiate one or more aspects of prioritized CSI reporting for AI/ML may be based on (e.g., reliant/linked) to one or more other configurations. For example, the network may determine that a WTRU is capable of one or more aspects of configuration adaptation to support prioritized CSI reporting for AI/ML, for example, the activation, state, and/or configuration of one or more of the following: the configuration of an AI/ML model and/or functionality; activation of an AI/ML model and/or functionality; and/or availability of an AI/ML model and/or functionality.

In examples, the capability and/or support for initiation of one or more aspects of configuration adaptation to prioritized CSI reporting for AI/ML may be based on one or more characteristics and/or configurations and/or parameters associated with the WTRU. For example, the capability and/or support for initiation of one or more aspects of configuration adaptation to prioritized CSI reporting for AI/ML may be based on performance of an AI/ML model and/or functionality, WTRU speed, remaining WTRU power, WTRU processing ability, WTRU location (e.g., within a certain set of cells, using one of a set of specific beams, global positioning system (GPS) location, etc.), and/or when a particular type of service is in use (e.g., related to one or more specific network slices and/or quality of service (QoS) class identifiers (QCIs)).

If a WTRU is configured for prioritized CSI reporting for AI/ML and/or an associated configuration is not present and/or active and/or the WTRU characteristics and/or configurations and/or parameters may not be suitable, the WTRU may determine that the procedure is (e.g., temporarily) disabled (e.g., the WTRU may not initiate the procedure) and/or inactive. The WTRU may indicate (e.g., subject to configuration) to the network that prioritized CSI reporting for AI/ML is (e.g., temporarily) inactive (e.g., via a MAC CE, uplink control information (UCI), and/or RRC signaling. In examples, the WTRU may report the reason for why the procedure is inactive (e.g., a joint configuration is disabled, and/or the WTRU characteristics and/or configurations and/or parameters may not be suitable).

In examples, the network may indicate support for prioritized CSI reporting for AI/ML. Support for prioritized CSI reporting for AI/ML may be, for example, per cell, per public land mobile network (PLMN), and/or per tracking area (TA) and/or RAN notification area (RNA). The indication may be, for example, a flag and/or a bit in system information, which may indicate support for prioritized CSI reporting for AI/ML. In examples, the network may indicate support for an aspect of the procedure (e.g., that the cell supports one or more activated CSI configurations but not based on priority, etc.). In examples, the network may indicate (e.g., within system information and/or via RRC configuration) a list of one or more cell(s) which support prioritized CSI reporting for AI/ML.

In examples, the WTRU may (e.g., only) initiate prioritized CSI reporting for AI/ML and/or one or more aspects of prioritized CSI reporting for AI/ML subject to the network supporting the procedure. For example, the WTRU may (e.g., only) prioritize a CSI report configuration if the cell has indicated support for prioritized CSI reporting for AI/ML.

In examples, a WTRU may activate one or more CSI report configurations of the one or more CSI report configurations. The activation may be based on one or more of the following.

A WTRU may activate of one or more CSI report configurations may be based on a WTRU applicability report. For example, the WTRU may activate one or more applicable periodic CSI report configurations based on receiving the configuration (e.g., based on receiving RRCReconfigurationComplete). In examples, the WTRU may apply different reporting configuration (e.g., sub configuration) for each CSI report configuration based on applicability (and/or evaluated prediction accuracy). For example, if a CSI report is applicable (and/or prediction accuracy is higher than a threshold), the WTRU may report the CSI report with a first CSI reporting configuration (e.g., with a first periodicity, a first offset, a first reporting bandwidth in a first UL resource). If a CSI report is not applicable (and/or prediction accuracy is lower than a threshold), for example, the WTRU may report the CSI report with a second CSI reporting configuration (e.g., with a second periodicity, a second offset, a second reporting bandwidth in a second UL resource).

A WTRU may activate one or more CSI report configurations based on gNB indication. For example, the WTRU may activate one or more semi-persistent CSI report configurations based on receiving a gNB activation message (e.g., via DCI and/or MAC CE). For example, the WTRU may activate semi-persistent CSI with PUCCH reporting configuration(s) via MAC CE. For example, the WTRU may activate semi-persistent CSI with PUSCH reporting configurations via DCI. The WTRU may activate one or more aperiodic CSI report configurations based on receiving a trigger (e.g., via DCI). The one or more semi-persistent and/or aperiodic CSI report configurations may be applicable to CSI report configuration(s) (e.g., via WTRU applicability report).

In examples, the WTRU may determine priority of the one or more CSI report configurations. Determination of the priority of the one or more CSI report configurations may be based on one or more of the following.

The WTRU may determine priority of the one or more CSI report configurations based on a gNB indication. For example, the WTRU may receive an indication of priority (e.g., for each CSI report configuration). The indication may be based on one or more of RRC, MAC CE, and/or DCI.

The WTRU may determine priority of the one or more CSI report configurations based on CSI report configuration type. For example, CSI report configuration(s) for AI/ML may be prioritized (e.g., over other CSI report configurations and/or lower-layer triggered mobility (LTM) CSI Report configurations).

The WTRU may determine priority of the one or more CSI report configurations based on a CSI prediction accuracy. For example, CSI report configuration(s) with prediction accuracy above a threshold (e.g., configured/indicated via one or more of RRC, MAC, and/or DCI) may be prioritized.

The WTRU may determine priority of the one or more CSI report configurations based on one or more configured parameters of each CSI report configuration. For example, a first CSI report configuration may be prioritized over a second CSI report configuration based on configured parameters of the first CSI report configuration and/or the second CSI report configuration. The configured parameters may include one or more of the following. The configured parameters may include a use case. For example, AI/ML for beam management may be prioritized over AI/ML for CSI. AI/ML for CSI may be prioritized over AI/ML for positioning. For example, spatial domain beam prediction (e.g., BM-Case1) may be prioritized over temporal domain beam prediction (e.g., BM-Case2). In examples, temporal domain beam prediction (e.g., BM-Case2) may be prioritized over spatial domain beam prediction (e.g., BM-Case1). The configured parameters may include RS type. For example, CSI report configuration with a first RS type (e.g., CSI-RS/SSB) may be prioritized over a second RS type (e.g., SSB/CSI-RS). The configured parameters may include a number of RS ports. For example, a first CSI report configuration with a larger number of RS ports may be prioritized over a second CSI report configuration with smaller number of RS ports (e.g., for Set A (RS resource set for beam prediction)). For example, a first CSI report configuration with smaller number of RS ports may be prioritized over a second CSI report configuration with larger number of RS ports (e.g., for set B (RS resource set for measurement for inference)). The configured parameters may include a transmission periodicity. For example, a first CSI report configuration with longer periodicity RS resources may be prioritized over a second CSI report configuration with shorter periodicity RS resources (e.g., for Set B (RS resource set for beam inference)). For example, a first CSI report configuration with shorter periodicity RS resources may be prioritized over a second CSI report configuration with longer periodicity RS resources. The configured parameters may include a reporting periodicity. For example, a first CSI report configuration with longer reporting periodicity may be prioritized over a second CSI report configuration with shorter reporting periodicity. For example, a first CSI report configuration with shorter reporting periodicity may be prioritized over a second CSI report configuration with longer reporting periodicity. The configured parameters may include CSI prediction accuracy. For example, a first CSI report configuration with stronger prediction accuracy may be prioritized over a second CSI report configuration with weaker prediction accuracy. The configured parameters may include indicated applicability. For example, a first CSI report configuration may be applicable and prioritized over a second CSI report configuration that is non-applicable. The WTRU may determine the first priority and/or the second priority based on one or more of an indication and/or one or more parameters associated with each (e.g., AI/ML) CSI report configuration (e.g., of the plurality of CSI report configurations). The one or more parameters may include a use case, a RS type, a number of RS ports, a transmission periodicity, and/or a reporting periodicity.

In examples, a WTRU may determine a (e.g., common) priority regardless of type of CSI report configuration(s). For example, a (e.g., common) priority may be used for (e.g., both) AI/ML CSI report configuration(s) and/or non-AI/ML CSI report configuration(s).

In examples, a WTRU may determine different priorities (e.g., based on a type of CSI report configuration(s)). For example, the WTRU may determine a (e.g., common) priority for non-AI/ML CSI report configuration(s). The WTRU may determine a (e.g., common) priority and/or an AI/ML priority for AI/ML CSI report configuration(s). In examples, the WTRU may compare the (e.g., common) priority. If two CSI report configurations have the same (e.g., common) priority, for example, the WTRU may compare the AI/ML priority and/or may prioritize CSI report configuration with higher AI/ML priority.

A WTRU may determine priority based on one or more of the following. The WTRU may determine priority of one or more CSI report configurations and/or corresponding prediction accuracy (e.g., only for AI/ML CSI report configurations). For example, AI/ML CSI report configuration(s) may be prioritized when corresponding prediction accuracy is higher than a threshold. Otherwise, AI/ML CSI report configuration(s) may be deprioritized. For example, when a WTRU is not able to report one or more (e.g., all) of the CSI reports according to the configured CSI report configuration(s), the WTRU may deprioritize (e.g., drop, not update) CSI report(s) associated with low priority CSI report configurations. A WTRU may be configured with one or more of the following equations to determine priority. For example, one or more of the following equations may be used for determination of priority.

A WTRU may use Equation (1) to determine priority of one or more CSI report configurations.

$$P r {i}_{iCSI} ( y , k , c , s ) = 2 \cdot {N}_{c e l l s} \cdot {M}_{s} \cdot y + {N}_{c e l l s} \cdot {M}_{s} \cdot k + {M}_{s} \cdot c + s \qquad Equation ( 1 )$$

In Equation (1), y may indicate one or more of the following. For example, y=0 for aperiodic CSI reports to be carried on PUSCH, y=1 for semi-persistent CSI reports to be carried on PUSCH, y=2 for semi-persistent CSI reports to be carried on PUCCH, and/or y=3 for periodic CSI reports to be carried on PUCCH. In Equation (1), k may indicate one or more of the following. For example, k=0 for CSI reports carrying L1-RSRP and/or L1-SINR, and/or k=1 for CSI reports not carrying L1-RSRP and/or L1-SINR. In Equation (1), c may be the serving cell index and/or N_{cells} may be the value of the higher layer parameter maxNrofServingCells. In Equation (1), s may be the reportConfiglD and/or Mₛ may be the value of the higher layer parameter maxNrofCSI-ReportConfigurations.

A WTRU may use Equation (2) to determine priority of one or more CSI report configurations.

$$P r {i}_{iCSI} ( a , y , k , c , s ) = 3 \cdot {N}_{c e l l s} \cdot {M}_{s} \cdot a + 2 \cdot {N}_{c e l l s} \cdot {M}_{s} \cdot y + {N}_{c e l l s} \cdot {M}_{s} \cdot k + {M}_{s} \cdot c + s \qquad Equation ( 2 )$$

In Equation (2), in examples, a may indicate one or more of the following. IF CSI report configuration for AI/ML and corresponding prediction accuracy is higher than a corresponding threshold (and/or if the CSI report configuration is appliable), a=0. If CSI report configuration is for non-AI/ML, a=1. If CSI report configuration is for AI/ML and corresponding prediction accuracy is lower than a corresponding threshold (and/or if the CSI report configuration is not applicable), a=2.

In Equation (2), in examples, if CSI report configuration is for AI/ML and corresponding prediction accuracy is higher than a corresponding threshold (and/or if the CSI report configuration is applicable, a=0. Otherwise, a=1.

In Equation (2) examples, if CSI report configuration is for AI/ML, a=0. Otherwise, a=1.

A WTRU may use Equation (3) to determine priority of one or more CSI report configurations, for example, when the WTRU is not able to report one or more (e.g., all) of the CSI reports.

$$P r {i}_{iCSI} ( a , y , k , c , s ) = a \cdot ( 2 \cdot {N}_{c e l l s} \cdot {M}_{s} \cdot y + {N}_{c e l l s} \cdot {M}_{s} \cdot k + {M}_{s} \cdot c + s ) \qquad Equation ( 3 )$$

In Equation (3), in examples, if CSI report configuration is for AI/ML and corresponding prediction accuracy is higher than a corresponding threshold (and/or if the CSI report configuration is applicable, a=1. If CSI report configuration is for non-AI/ML, a=2. If CSI report configuration is for AI/ML and corresponding prediction accuracy is lower than a corresponding threshold (and/or if the CSI report configuration is not applicable), a=3.

In Equation (3), in examples, if CSI report configuration is for AI/ML and corresponding prediction accuracy is higher than a corresponding threshold (and/or if the CSI report configuration is applicable, a=0. If CSI report configuration is for non-AI/ML, a=1. If CSI report configuration is for AI/ML and corresponding prediction accuracy is lower than a corresponding threshold (and/or if the CSI report configuration is not applicable), a=2.

In Equation (3), in examples, if CSI report configuration is for AI/ML and corresponding prediction accuracy is higher than a corresponding threshold (and/or if the CSI report configuration is applicable, a=0. Otherwise, a=1.

In Equation (3), in examples, if CSI report configuration is for AI/ML, a=0. Otherwise a=1.

The WTRU may determine priority of one or more CSI report configurations and/or corresponding prediction accuracy (e.g., only for AI/ML CSI report configurations). For example, a first AI/ML report configuration may have a higher priority over a second CSI report configuration based on configured parameters of the first CSI report configuration and/or the second CSI report configuration. The configured parameters may include one or more of the following. The configured parameters may include a use case. For example, AI/ML for beam management may be prioritized over AI/ML for CSI. AI/ML for CSI may be prioritized over AI/ML for positioning. For example, spatial domain beam prediction (e.g., BM-Case1) may be prioritized over temporal domain beam prediction (e.g., BM-Case2). In examples, temporal domain beam prediction (e.g., BM-Case2) may be prioritized over spatial domain beam prediction (e.g., BM-Case1). The configured parameters may include RS type. For example, CSI report configuration with a first RS type (e.g., CSI-RS/SSB) may be prioritized over a second RS type (e.g., SSB/CSI-RS). The configured parameters may include a number of RS ports. For example, a first CSI report configuration with a larger number of RS ports may be prioritized over a second CSI report configuration with smaller number of RS ports (e.g., for Set A (RS resource set for beam prediction)). For example, a first CSI report configuration with smaller number of RS ports may be prioritized over a second CSI report configuration with larger number of RS ports (e.g., for set B (RS resource set for measurement for inference)). The configured parameters may include a transmission periodicity. For example, a first CSI report configuration with longer periodicity RS resources may be prioritized over a second CSI report configuration with shorter periodicity RS resources (e.g., for Set B (RS resource set for beam inference)). For example, a first CSI report configuration with shorter periodicity RS resources may be prioritized over a second CSI report configuration with longer periodicity RS resources. The configured parameters may include a reporting periodicity. For example, a first CSI report configuration with longer reporting periodicity may be prioritized over a second CSI report configuration with shorter reporting periodicity. For example, a first CSI report configuration with shorter reporting periodicity may be prioritized over a second CSI report configuration with longer reporting periodicity. The configured parameters may include CSI prediction accuracy. For example, a first CSI report configuration with stronger prediction accuracy may be prioritized over a second CSI report configuration with weaker prediction accuracy. The configured parameters may include an indicated applicability. For example, a first CSI report configuration may be applicable and prioritized over a second CSI report configuration that is non-applicable. The WTRU may determine the first priority and/or the second priority based on one or more of an indication and/or one or more parameters associated with each (e.g., AI/ML) CSI report configuration (e.g., of the plurality of CSI report configurations). The one or more parameters may include a use case, a RS type, a number of RS ports, a transmission periodicity, and/or a reporting periodicity. For example, priority associated with CSI report configuration may not be based on applicability.

In examples, a WTRU may apply the determined priority(ies) for one or more of the following cases. When one or more (e.g., multiple) CSI reports collide, the WTRU may apply the determined priority(ies). For example, when one or more CSI reports are configured and/or activated to be reported and the WTRU may not be capable of reporting the one or more CSI reports (e.g., simultaneously), the WTRU may report a CSI report with higher priority. The WTRU may apply the determined priority(ies) when the WTRU is processing/calculating/evaluating one or more CSI reports (e.g., simultaneously) and (e.g., required) CPUs of the one or more reports may be beyond WTRU capability. In examples, the WTRU may determine one or more CSI reports to be updated based on the determined priorities. For example, the WTRU may (e.g., only) update CSI reports with higher priority(ies).

In examples, if the WTRU applies the determined priority(ies), the WTRU may apply the determined priority(ies) based on one or more of the following. When the priorities of corresponding CSI report configurations are the same, for example, the WTRU may prioritize CSI report configuration(s) with higher priority. The WTRU may compare the AI/ML priority(ies) if one or more of the following are satisfied. The WTRU may compare the AI/ML priority(ies) if the priority(ies) of corresponding CSI report configurations are the same. The WTRU may compare the AI/ML priority(ies) if one or more (e.g., multiple) AI/ML report configurations are activated for the same usage. The same usage may refer to when one or more of the following are the same between two AI/ML CSI report configurations: RS transmission type (e.g., periodic, semi-static, and/or aperiodic); report type (e.g., periodic, semi-static, and/or aperiodic); functionality and/or purpose (e.g., CSI, BM, and/or positioning); a target scenario; a report quantity; and/or the like.

In examples, a WTRU may apply AI/ML based priority (and/or priority with AI/ML related parameters) for (e.g., only) CSI report configurations configured for applicability reporting. AI/ML based priority (and/or (e.g., non-AI/ML) priority with AI/ML related parameters) may not be applied for CSI reporting configurations from sets of interference related parameters.

In examples, the WTRU may apply AI/ML based priority (and/or (e.g., non-AI/ML) priority with AI/ML related parameters) for (e.g., only) periodic CSI report configuration(s). AI/ML based priority (and/or (e.g., non-AI/ML) priority with AI/ML related parameters) may not be applied for aperiodic and/or semi-persistent CSI report configurations.

In examples, a WTRU may indicate different information (e.g., to a gNB) based on the determined priority(ies) and/or the determined CSI report configurations to be reported and/or updated. The indication may be based on one or more of RRC, MAC CE, PUCCH (e.g., UCI), PUSCH, PRACH, and/or UL RS. For example, one or more of the following may be used. In examples, the WTRU may indicate the determined a value for priority equation. In examples, the WTRU may indicate CSI report configuration ID, which may be prioritized and/or reported and/or updated.

In examples, the WTRU may receive (e.g., via one or more of RRC, MAC-CE, and/or DCI) a configuration of a priority between one or more CSI report configurations (e.g., for CSI-report configuration(s) associated with one or more of the same functionalities).

In examples, the WTRU may (e.g., only) activate one CSI report configuration among one or more (e.g., multiple) configured and/or applicable CSI report configurations. For example, if one or more (e.g., multiple) CSI report configurations are configured for the same usage, the WTRU may activate (e.g., only) one CSI report configuration among the one or more CSI report configurations. The (e.g., only) one CSI report configuration may be determined based on the determined priority(ies).

In examples, the WTRU may report (e.g., via UE assistance information (UAI) report, applicability report) applicability of one or more CSI-report configurations. Based on the condition that more than one CSI-report configurations may be applicable, for example, the WTRU may determine a priority and/or preference between applicable AI/ML-CSI-report configurations based on one or more of the following. The WTRU may determine a priority and/or preference between applicable AI/ML-CSI-report configurations based on WTRU capability (e.g., CPU capability and/or AI/ML-CPU capability). The WTRU may prioritize a CSI-report associated with smaller CPU load (e.g., CSI-report configuration associated with a smaller number of RSs to be measured) for the CPU. The WTRU may determine a priority and/or preference between applicable AI/ML-CSI-report configurations based on WTRU speed. In examples, the WTRU may prioritize a first CSI-report configuration associated with a first periodicity for CSI-report transmission when WTRU speed is less than a threshold. The WTRU may prioritize a second CSI-report configuration associated with a second (e.g., shorter than first) periodicity for CSI-report transmission when the WTRU speed is greater than the threshold. The WTRU may determine a priority and/or preference between applicable AI/ML-CSI-report configurations based on a prediction type. In examples, the WTRU may prioritize CSI-report configuration(s) associated with BM-Case1 and/or BM-Case2. The WTRU may determine a priority and/or preference between applicable AI/ML-CSI-report configurations based on RS transmission type. In examples, the WTRU may prioritize CSI-report configuration(s) associated with periodic, semi-periodic, and/or aperiodic RS resources. The WTRU may determine a priority and/or preference between applicable AI/ML-CSI-report configurations based on CSI-report transmission type. In examples, the WTRU may prioritize CSI-report configuration associated with periodic, semi-periodic, and/or aperiodic CSI-report. The WTRU may determine a priority and/or preference between applicable AI/ML-CSI-report configurations based on AI/ML associated with CSI-report configuration(s). In examples, the WTRU may prefer an AI/ML model associated with a CSI-report configuration and/or may prioritize the CSI-report configuration associated with the preferred AI/ML model. The WTRU may determine a priority and/or preference between applicable AI/ML-CSI-report configurations based on a prediction quality. The WTRU may prioritize the CSI-report configuration(s) associated with the highest prediction quality (e.g., beam prediction accuracy). The WTRU may determine a priority and/or preference between applicable AI/ML-CSI-report configurations based on a gNB pre-configuration and/or indication. In examples, the WTRU may active the applicable CSI-report configurations based on the pre-configuration and/or indication form the gNB.

In examples, the WTRU may indicate a preferred and/or prioritized CSI-report configuration in the applicability report. In examples, the WTRU may activate one or more CSI-report configurations based on one or more of the following. The WTRU may activate one or more CSI-report configurations based on gNB pre-configuration and/or indication of a priority. In examples, the WTRU may activate the applicable CSI-report configuration(s) (e.g., based on reception of RRCReconfigurationComplete for CSI-report configuration associated with periodic CSI-report) based on the pre-configured and/or pre-indicated priority of CSI-report configuration(s). For example, the gNB may determine the priority; the WTRU may receive the indication and/or may determine the priority based on the indication. The WTRU may activate one or more CSI-report configurations based on gNB activation of CSI-report configuration(s). The WTRU may receive an activation configuration and/or indication (e.g., RRC RRCReconfigurationComplete, MAC CE activation, and/or DCI indication for CSI-report configuration(s) associated with periodic, semi-persistent, and/or aperiodic CSI-report, respectively) associated with one or more CSI-report configurations. In examples, the activation configuration and/or indication may be received for preferred and/or prioritized CSI-report configuration(s) indicated by the WTRU.

A WTRU may adapt (e.g., change) the priority and/or preference of a CSI report configuration(s) based on the WTRU characteristics (e.g., WTRU speed and/or position, WTRU power and/or battery level, WTRU processing capability and/or load).

Upon detection of change in WTRU characteristics, for example, the WTRU may modify the priority and/or preference of one or more aspects of the current configuration and/or may apply another (e.g., new) configuration. How the WTRU may detect which aspect(s) of the configuration to change and/or how the priority may change may be based on condition(s) associated with the configuration and/or aspect(s) of the configuration. For example, the WTRU may be provided with one or more threshold(s). If a threshold is exceeded (and/or if a value has fallen below a threshold), for example, the WTRU may apply an alternative priority for the configuration.

A WTRU may determine priority of CSI report configurations based on CSI report configuration parameters and/or prediction performance of CSI report configurations.

A WTRU may receive one or more CSI report configurations. Each CSI report configuration may include at least one or more of the following parameters: A reference signal (RS) resource set for set A, a RS resource set for set B, a ReportQuantity, a CSI reporting configuration type (e.g., AI/ML and/or non-AI/ML), and/or a transmission type (e.g., periodic, semi-static, and/or aperiodic). For example, the WTRU may receive configuration information that indicates a first AI/ML CSI report configuration, a second AI/ML CSI report configuration, a first CSI reporting configuration type associated with the first AI/ML CSI report configuration, and/or a second CSI reporting type associated with the second AI/ML CSI report configuration. The WTRU may receive configuration information that indicates a plurality of CSI report configuration and/or a respective CSI reporting configuration type associated with each CSI report configuration of the plurality of CSI report configurations. The plurality of CSI report configurations may include one or more (e.g., at least two) AI/ML CSI report configurations. The configuration information may include non-AI/ML CSI report configurations. The configuration information may include a plurality of CSI report configurations. The plurality of CSI report configurations may include one or more non-AI/ML CSI report configuration(s). The plurality of CSI report configurations may include a first CSI report configuration and/or a second CSI report configuration. The configuration information may include respective functionality for each CSI report configuration of the plurality of CSI report configurations. Each functionality may be indicative of a purpose and/or task (e.g., purpose and/or task the WTRU is to perform). For example, functionality and/or purpose and/or task associated with each CSI report configuration may include a CSI (e.g., related) purpose and/or task, a beam management (e.g., related) purpose and/or task, and/or a positioning (e.g., related) purpose and/or task. Each functionality and/or usage may be indicative of each CSI report configuration of the plurality of CSI report configurations.

The WTRU may determine whether each (e.g., the first and/or the second) AI/ML CSI report is applicable. For example, the WTRU may determine whether each (e.g., the first and/or the second) AI/ML CSI report is applicable based at least on one or more characteristics and/or parameters and/or configurations associated with each AI/ML CSI report configuration and/or the usage and/or functionality (e.g., as described herein). There may be no determination of applicability associated with non-AI/ML CSI report configuration(s), for example, because non-AI/ML CSI report configurations may (e.g., always) be applicable. The one or more (e.g., first and/or second) AI/ML CSI report configurations may be activated based on a determination that each (e.g., first and/or second) AI/ML CSI report configuration is applicable. For example, the WTRU may activate the first AI/ML CSI report configuration based on a determination that the first AI/ML CSI report configuration is applicable. For example, the WTRU may activate the second AI/ML CSI report configuration based on a determination that the second AI/ML CSI report configuration is applicable.

The WTRU may indicate one or more of the applicable CSI report configurations of the one or more CSI report configurations. For example, the WTRU may send an indication that indicates applicability of each (e.g., the first and/or the second) AI/ML CSI report configuration (e.g., of at least two AI/ML CSI report configurations). The WTRU may send an indication that indicates applicability of the first AI/ML CSI report configuration and/or the second AI/ML CSI report configuration.

The WTRU may activate the one or more CSI report configurations based on the applicability and/or the transmission type. For example, periodic CSI report configurations may be activated based on the configuration (e.g., after RRCReconfigurationComplete). For example, semi-persistent CSI with physical uplink control channel (PUCCH) reporting configurations may be activated via medium access control control element (MAC-CE). For example, semi-persistent CSI with physical uplink shared channel (PUSCH) reporting configurations may be activated via downlink control information (DCI). For example, aperiodic CSI reporting may be triggered via DCI.

The WTRU may determine priority of one or more CSI report configurations. Priority can be determined based on a (e.g., common) rule. For example, the WTRU may not determine the priority based on prediction performance. In examples, the WTRU and/or the gNB may (e.g., both) determine priority based on (pre)defined rules (e.g., a priority equation). The WTRU may determine priority of the one or more CSI report configurations and/or corresponding prediction accuracy (e.g., only for AI/ML CSI report configurations). For example, AI/ML CSI report configurations may be prioritized when corresponding prediction accuracy is higher than a threshold. Otherwise, AI/ML CSI report configuration(s) may be deprioritized. For example, when a WTRU is not able to report one or more (e.g., all) of the CSI reports according to the configured CSI report configuration(s), the WTRU may deprioritize (e.g., drop, not update) CSI report(s) associated with low priority CSI report configurations. For example, when the prediction accuracy corresponding to the first or second AI/ML CSI report configuration is lower than the threshold, the WTRU may remove a priority associated with the first or second AI/ML CSI report configuration. For example, the WTRU may use one or more equations to determine priority of one or more CSI report configurations (e.g., based on Pri_{iCSI}(α, y, k, c, s)=3·N_{cells}·Mₛ·α+2·N_{cells}·Mₛ·y+N_{cells}·Mₛ·k+Mₛ·c+s). Where a=0 if CSI report configuration is for AI/ML and corresponding prediction accuracy is higher than a corresponding threshold. a=1 if CSI report configuration is for non-AI/ML. a=2 if CSI report configuration is for AI/ML and corresponding prediction accuracy is lower than a corresponding threshold. For example, the WTRU may determine a first priority associated with each (e.g., AI/ML) CSI report configuration (e.g., of the plurality of CSI report configurations) based on a prediction accuracy associated with each (e.g., first and/or second AI/ML) CSI report configuration and/or the (e.g., first and/or second) CSI report configuration types. The WTRU may determine the first priority based on the non-AI/ML CSI report configuration(s), the first AI/ML CSI report configuration, and/or the second AI/ML CSI report configuration. The WTRU may determine the first priority based on WTRU capability(ies) (e.g., as described herein).

If one or more AI/ML CSI report configurations are activated for the same usage, the WTRU may determine AI/ML priority for the AI/ML CSI report configurations of the one or more CSI report configurations. The same usage may refer to when one or more of the following (e.g., parameters, configurations) are the same between two AI/ML CSI report configurations: RS transmission type (e.g., periodic, semi-static, and/or aperiodic), report type (e.g., periodic, semi-static, and/or aperiodic), functionality (CSI, BM, and/or positioning), a target scenario (e.g., BM Case 1 or BM Case 2), a ReportQuantity, and/or the like. For example, the WTRU may determine a second priority based on the first and second AI/ML CSI report configuration (e.g., of the plurality of CSI report configurations) being activated for the same usage. The WTRU may determine the second priority based on whether the prediction accuracy of each (e.g., first and/or second) AI/ML CSI report configuration is above a threshold (e.g., as described herein) and/or based on one or more characteristics and/or parameters and/or configurations associated with each AI/ML CSI report configuration. The WTRU may determine the second priority when the priority associated CSI report configuration is the same priority associated with the second CSI report configuration.

The WTRU may prioritize AI/ML CSI report with the same usage based on one or more of the following. The WTRU may prioritize AI/ML CSI report based on a determination to prioritize BM-Case1 over BM-Case 2. The WTRU may prioritize AI/ML CSI report based on a determination to prioritize a larger number of CSI-RS ports (e.g., may be for Set A). The WTRU may prioritize AI/ML CSI report based on a determination to prioritize a smaller number of CSI-RS ports (e.g., may be for Set B). The WTRU may prioritize AI/ML CSI report based on a determination to prioritize shorter transmission periodicity. The WTRU may prioritize AI/ML CSI report based on a determination to prioritize a larger reporting periodicity. The WTRU may prioritize AI/ML CSI report based on a determination to prioritize stronger CSI prediction accuracy.

The WTRU may report CSI based on the determined priority and/or the AI/ML priority. For example, the WTRU may send an indication of CSI associated with at least the AI/ML CSI report configuration based on the first priority and/or the second priority. The WTRU may send information associated with the first and/or second priority associated with the plurality of CSI report configurations to send the indication of CSI. When the WTRU is not able to report and/or update one or more (e.g., all) of the CSI reportings based on the one or more CSI report configurations. If one or more CSI report configurations collide, the WTRU may report CSI based on a CSI report configuration with higher priority and higher AI/ML priority (e.g., if priority of CSI report configurations are the same). If one or more CSI report configurations require CPUs more than WTRU capability, the WTRU may update CSI based on a CSI report configuration with higher priority and higher AI/ML priority (e.g., if priority of CSI report configurations are the same).

1. A wireless transmit/receive unit (WTRU) comprising:
a processor configured to:
receive configuration information, wherein the configuration information indicates a first artificial intelligence or machine learning (AI/ML) channel state information (CSI) report configuration, a second AI/ML CSI report configuration, a first CSI reporting configuration type associated with the first AI/ML CSI report configuration, and a second CSI reporting configuration type associated with the second AI/ML CSI report configuration;
send an indication that indicates applicability of the first AI/ML CSI report configuration or the second AI/ML CSI report configuration;
determine a first priority associated with each CSI report configuration based on 1) a prediction accuracy associated with each AI/ML CSI report configuration and 2) the first or second CSI reporting configuration type;
determine a second priority based on the first or second AI/ML CSI report configurations being activated for the same usage, wherein the second priority is determined based on whether the prediction accuracy of each AI/ML CSI report configuration is above a threshold and one or more configurations associated with each AI/ML CSI report configuration; and
send an indication of CSI associated with at least the AI/ML CSI report configuration based on the first priority or the second priority.

2. The WTRU of claim 1, wherein the configuration information comprises non-AI/ML CSI report configurations, and wherein the first priority is determined based on the non-AI/ML CSI report configurations, the first AI/ML CSI report configuration, or the second AI/ML CSI report configuration.

3. The WTRU of claim 1, wherein the second priority is determined when the priority associated with the first CSI report configuration is the same priority associated with the second CSI report configuration.

4. The WTRU of claim 1, when the prediction accuracy corresponding to the first or second AI/ML CSI report configuration is lower than the threshold, the processor is further configured to determine a lower priority associated with the first or second AI/ML CSI report configuration.

5. The WTRU of claim 1, wherein the configuration information comprises respective usage for each CSI report configuration of the plurality of CSI report configurations wherein each respective usage is indicative of a purpose of each CSI report configuration, wherein the purpose comprises one or more of a CSI purpose, a beam management purpose, or a positioning purpose.

6. The WTRU of claim 1, wherein the configuration information comprises a plurality of CSI report configurations, wherein the plurality of CSI report configurations comprise the first AI/ML CSI report configuration and the second AI/ML CSI report configuration, and wherein the processor is configured send information associated with the first or second priority associated with the plurality of CSI report configurations to send the indication of CSI.

7. The WTRU of claim 1, wherein the processor is further configured to determine applicability associated with each AI/ML CSI report configuration based at least on one or more configurations associated with each AI/ML CSI report configuration or the functionality.

8. The WTRU of claim 7, wherein the first or second AI/ML CSI report configuration is activated based on a determination that the first or second AI/ML CSI report configuration is applicable.

9. The WTRU of claim 1, wherein the first priority or the second priority is determined based on WTRU capability.

10. The WTRU of claim 1, wherein the first priority or the second priority is determined based on one or more of an indication or one or more parameters associated with each CSI report configuration, wherein the one or more parameters comprise one or more of a use case, a reference signal (RS) type, a number of RS ports, a transmission periodicity, or a reporting periodicity.

11. A method performed by a wireless transmit/receive unit (WTRU), the method comprising:
receiving configuration information, wherein the configuration information indicates a first artificial intelligence or machine learning (AI/ML) channel state information (CSI) report configuration, a second AI/ML CSI report configuration, a first CSI reporting configuration type associated with the first AI/ML CSI report configuration, and a second CSI reporting configuration type associated with the second AI/ML CSI report configuration;
sending an indication that indicates applicability of the first AI/ML CSI report configuration or the second AI/ML CSI report configuration;
determining a first priority associated with each CSI report configuration based on 1) a prediction accuracy associated with each AI/ML CSI report configuration and 2) the first or second CSI reporting configuration type;
determining a second priority based on the first or second AI/ML CSI report configurations being activated for the same usage, wherein the second priority is determined based on whether the prediction accuracy of each AI/ML CSI report configuration is above a threshold and one or more configurations associated with each AI/ML CSI report configuration; and
sending an indication of CSI associated with at least the AI/ML CSI report configuration based on the first priority or the second priority.

12. The method of claim 11, wherein the configuration information comprises non-AI/ML CSI report configurations, and wherein the first priority is determined based on the non-AI/ML CSI report configurations, the first AI/ML CSI report configuration, or the second AI/ML CSI report configuration.

13. The method of claim 11, wherein the second priority is determined when the priority associated with the first CSI report configuration is the same priority associated with the second CSI report configuration.

14. The method of claim 11, when the prediction accuracy corresponding to the first or second AI/ML CSI report configuration is lower than the threshold, the method further comprising determining a lower priority associated with the first or second AI/ML CSI report configuration.

15. The method of claim 11, wherein the configuration information comprises respective usage for each CSI report configuration of the plurality of CSI report configurations, wherein each respective usage is indicative of a purpose of each CSI report configuration, wherein the purpose comprises one or more of a CSI purpose, a beam management purpose, or a positioning purpose.

16. The method of claim 11, wherein the configuration information comprises a plurality of CSI report configurations, wherein the plurality of CSI report configurations comprise the first AI/ML CSI report configuration and the second AI/ML CSI report configuration, and wherein the method further comprising sending information associated with the first or second priority associated with the plurality of CSI report configurations to send the indication of CSI.

17. The method of claim 11, further comprising determining applicability associated with each AI/ML CSI report configuration based at least on one or more configurations associated with each AI/ML CSI report configuration or the functionality.

18. The method of claim 17, wherein the first or second AI/ML CSI report configuration is activated based on a determination that the first or second AI/ML CSI report configuration is applicable.

19. The method of claim 11, wherein the first priority or the second priority is determined based on WTRU capability.

20. The method of claim 1, wherein the first priority or the second priority is determined based on one or more of an indication or one or more parameters associated with each CSI report configuration, wherein the one or more parameters comprise one or more of a use case, a reference signal (RS) type, a number of RS ports, a transmission periodicity, or a reporting periodicity.
